(19) United States
(12) Patent Application Publication
(10) Pub. No.: US 2007/0270518 A1
(43) Pub. Date: Nov. 22, 2007

(54) Phase-Stable Polyurethane Prepolymers

(76) Inventor: Rainer Nutzel, Weissbad (CH)

Correspondence Address: Robert Berliner;Berliner & Associates, 555 West Fifth Street, 31st Floor, Los Angeles, CA, 90013, US

(21) Appl. No.: 10/592,259

(22) PCT Filed: Feb. 10, 2005
(86) PCT No.: PCT/EP05/01328

§ 371 Date: May 23, 2007

(30) Foreign Application Priority Data
Mar. 8, 2004 (DE) 10 2004 011 559.1

(51) Int. Cl. C08G 18/00

(52) U.S. Cl. 521/159; 528/44

(57) ABSTRACT

The invention relates to phase-stable prepolymer compositions, in particular for producing polyurethane foams, said prepolymer composition containing polyurethane prepolymers obtained through a reaction of a first prepolymer component which contains polyester polyols with at least two hydroxy groups and non-polar constituents, and a second prepolymer component containing polyisocyanates having at least two isocyanate groups, said polyester polyols being transesterification products consisting of vegetable oils, polyethylene terephthalate and polyols. Said prepolymer component becomes more strongly hydrophobic by the use of polyester polyols that have been produced in this manner, permitting the use of chlorinated paraffins in higher concentration as flame retardant and softener, without segregation occurring. Furthermore, the invention also relates to a method for the production of the inventive prepolymer composition, pressurized containers and cartridges containing the prepolymer composition according to the invention, as well as the use of the inventive prepolymer composition to produce polyurethane foams.

The invention relates to a prepolymer composition, in particular for producing polyurethane foams, said composition containing polyurethane prepolymers obtained through a reaction of a first component which contains polyester polyols with at least two hydroxy groups and non-polar constituents, and a second component containing polyisocyanates having at least two isocyanate groups.

The inventive prepolymer composition serves the purpose of producing polyurethane insulating foams whose main fields of application are in the building trade. They are used for the installation of window and door frames and filling hollow spaces with foam, also in technical products where cavities have to be filled in order to prevent condensation water from accumulating.

As far as one-component polyurethane foams are concerned these are characterized by the prepolymer composition being released from pressurized containers, for example aerosol containers, with the help of propellants and discharged and applied locally and having a weight per unit of volume ranging between 10 and 100 g/l. For hardening one-component foams solely require air humidity, that is, under appropriate conditions the foams have moisture-hardening qualities.

Prepolymer compositions for two-component polyurethane foams need a second, usually hydroxy-group containing component for hardening. As a rule, a polyol is added in this case immediately before foam is produced. The polyurethane foam hardening process may be accelerated by means of catalysts. The typical weight per unit of volume of two-component foams ranges between 10 and 100 g/l. The second hydroxy-group containing component may comprise water as cross-linking agent. CO₂ resulting from the reaction with water promotes the formation of foam.

Furthermore, commonly used are also so-called 1.5-component polyurethane foams representing transient products between one- and two-component foams. To such 1.5-component polyurethane foams a hydroxy component is added to the prepolymer prior to discharge, with the amount of said component being insufficient to cause free isocyanate groups still present in the prepolymer from being converted. Foaming agents having more than one separate, reactive component also count among the 1.5-component foams.

Customary prepolymer compositions for polyurethane foams contain a prepolymer component containing a minimum of reactive NCO groups. The prepolymer itself is a polymer of suitable viscosity with terminal NCO groups. To obtain PU prepolymers having terminal NCO groups the usual practice is to cause the reaction of polyfunctional alcohols with an excess amount of monomeric polyisocyanates, as a rule mainly diisocyanate.

Suitable customary polyisocyanates are, for example, isophoron diisocyanate, also termed IPDI, toluylene diisocyanate, also termed TDI, 1,5-diisocyanatonaphthalene, also termed NDI, triisocyanatotrimethylmethane, 1,6-diisocyanatohexane, also termed HDI, and 4,4′-diisocyanatodiphenylmethane, usually referred to as MDI. All these initial substances may be used in raw form, i.e. as a mixture, or in the form of a pure isomer or blends of isomers or in the form of their reactive derivatives. As reactive derivatives primarily dimeric and trimeric forms of isocyanates as well as their biurets and allophanates may be employed. Important is that their functionality is ≧2.

For the production of polyurethane (PU) prepolymers said polyisocyanates are converted with hydroxy-group containing polyethers, polyesters or polyols where it must be ensured that the resulting prepolymer has a viscosity suited for the intended purpose. For the purpose of accelerating or bringing about the conversion catalysts are employed which are usually amine- or carboxylate-based catalysts.

For the conversion into a prepolymer polyols may be employed which are customarily used in this field. Especially, polyester polyols and polyether polyols as have been frequently described in literature have proven their worth, in particular those having an OH number in the range between 30 and 350.

Insulating foams put to use in the building trade must satisfy national regulations with respect to their fire retardant properties so that flame retarding agents are usually added to (PU) prepolymers. As can be seen from WO 94/18268, for example, softening phosphates or phosphonates may be used as flame retardants. Particularly suited for this purpose is tris-(2-chloropropyl)-phosphate (TMCP). TMCP may also serve as solutizer between polar and non-polar constituents.

Although TMCP is well suited as a flame retardant and softener it has nevertheless the drawback that it is comparatively expensive. For this reason there is a need for less expensive alternatives to TMCP as flame retardant that are capable of replacing the TMCP in the prepolymer composition in whole or in part.

Such less expensive flame retardants are, for example, chlorinated paraffins. The use of chlorinated paraffins and the like as flame retardants has been known basically for a long time, so far, however, a problem has been encountered in that the proportion of chlorinated paraffins in the polyol prepolymer component could not be increased in the presence of polyester polyols and/or polyether polyols to substantially more than 25 wt % because otherwise a segregation would occur as a result of the strongly hydrophobic characteristics of chlorinated paraffins. However, a segregation of the prepolymer composition leads to the production of foams that are unfit for purpose.

Proceeding from what is known from prior art it is therefore the objective of the invention to provide a prepolymer composition on polyester polyol basis that enables higher amounts of chlorinated paraffins to be added as flame retardants in comparison to prior-art solutions.

According to the invention this objective is achieved by providing a prepolymer composition of the nature mentioned hereinbefore in which the polyester polyols are transesterification products of vegetable or animal oils with aromatic di- and/or tricarbonic acids and their esters and anhydrides as well as polyols.

Furthermore, the invention also relates to a method for the production of the inventive prepolymer composition, the use of the inventive prepolymer composition to produce one-, 1.5- and two-component polyurethane foams as well as pressurized containers and cartridges containing the prepolymer composition according to the invention.

The invention is based on the consideration that from a transesterification reaction of, for example, terephthalic acid polyethers with vegetable oil polyester polyols of significantly stronger hydrophobic nature can be obtained than with actually using polyester polyols on terephthalic acid basis. In this context, the use of polyethylene terephthalate offers special advantages as there are numerous cost-efficient supply sources for this product, in particular since polyethylene terephthalate (PET) is widely employed in the production of beverage bottles and is available in the form of a recycle product.

The production of polyester polyols through the transformation of polyethylene terephthalate with polyols and vegetable oils is known basically from U.S. Pat. No. 6,133,329. Such polyester polyols, however, did not serve the purpose of producing prepolymers that are to be mixed with a propellant and kept in a pressurized container with a view to producing with them, when needed, polyurethane foam which, in particular, is used for applications in the building sector.

As per U.S. Pat. No. 6,133,329 recycled polyethylene terephthalate is dissolved in a blend of glycols, for example, diethylene glycol, triethylene glycol, tetraethylene glycol and/or pentaethylene glycol and heated to 232° C. for three hours. After cooling down to 149° C. non-transformed material is separated with a polyfunctional alcohol and a vegetable oil then being added to the filtrate. The mixture is distilled at 232° C. and 130 mbar until the expected amount of ethylene glycol has been separated which is indicative of the end of the reaction. If thought expedient, a catalyst such as the chelate complex triethanol amine titanate can be added to speed up the reaction. According to an alternative embodiment also phthalic acid anhydride is used aside from vegetable oil and polyfunctional alcohol. Phthalic acid diesters may also be applied, for example C₁-C₆ alkyl esters.

It is basically possible to use various types of polyols but in the framework of this invention compounds are deemed to be polyols that contain two or more hydroxy groups. Aside from the glycols mentioned particularly pentaerythritol and glycerine can be used as polyols.

Usable vegetable oils are, inter alia, sunflower oil, corn oil, soy bean oil, castor oil, palm oil, colza oil or groundnut oil. Aside from this, there are quite a number of other oils of vegetable nature that are suited, particularly those with unsaturated fatty acid remnants. Moreover, tall oil as well as numerous animal fats and oils, for example fish oil, may also be employed.

In comparison to known art the proportion of hydrophobic constituents as well as chlorinated paraffins in the prepolymer composition can be significantly raised. Considering the fact that, for instance, the chlorinated paraffin content in relation to the first prepolymer component containing the polyester polyols could not be increased, hitherto, to more than approx. 27 wt % such paraffin content can now be raised to up to 70 wt %. Preferably, it is thus ranges between 25 and 70 wt % in relation to the first prepolymer component. At the same time, the proportion of other flame retardants, especially TMCP which in customary compositions amounts to approx. 20 wt % of the first prepolymer component can be reduced accordingly. Ideally, TMCP is replaced altogether.

To further enhance the form, phase, and dimensional stability of the PU foams produced from the prepolymer composition it is expedient to add polyether polyols to the first component, i.e. in an amount that preferably ranges between 10 and 30 wt %, and particularly comes to approx. 20 wt %. The polyester polyols' content preferably is in the range of 20 to 80 wt %, especially preferred in the range of 25 to 45 wt %, in relation to the first prepolymer component.

The prepolymer compositions may furthermore contain vegetable oils as such, for example castor oil, in an amount of up to 30 wt %, in relation to the first prepolymer component.

In order to produce the inventive prepolymers proper, polyisocyanates are required as second prepolymer component, such polyisocyanates in this context being compounds that contain two or more isocyanate groups. As a rule this is diisocyanate. To ensure that the prepolymer contains a sufficient number of NCO groups an excess amount of polyisocyanates is usually employed. 4,4′-diisocyanatodiphenyl methane (MDI), isophoron diisocyanate (IPDI) and toluylene diisocyanate (TDI) have turned out to be specially suited in this respect. Particularly suitable catalysts enhancing the prepolymer formation are tertiary amines, especially derivatives of morpholines, as, for example, dimorpholinodimethyl ether, dimorpholinodiethyl ether, di-(2,6-dimethyl morpholinoethyl)ether and N-methyl morpholine. Further preferred tertiary amines are N,N,N′,N′-tetramethyl hexane-1,6-diamine, N,N,N′,N′-tetramethyl ethylene diphenyl-4,4′-diamine, N,N,N′,N′-tetramethyl methylene dihexyl-4,4′-diamine, N,N-dimethyl cyclohexylamine, N,N-dipropyl cyclohexylamine, N,N-dicyclo hexyl methylamine. The above named catalysts may be used both individually and as a mixture for the production of the prepolymer composition, a polymer composition for admixture with other polyisocyanates as well as for the hardening of the prepolymer.

Moreover, the prepolymer compositions according to the invention may contain additional customary additives. Aside from the flame retardants and catalysts already mentioned these are, among others, stabilizers, cell openers, softeners, emulgators, fungicides, pigments and antioxidants. If the prepolymer composition is employed to produce pressurized container foams a propellant is furthermore needed, in particular propane, butane and/or dimethyl ether. Also used as propellants may be fluorocarbons that can be liquefied under the pressure conditions prevailing in a pressurized container, for example R125, R134a, R143, R152a and R365 mfc. To keep the proportion of flammable and halogen-containing propellants low further gases may be added which do not condense under the pressure conditions prevailing in the pressurized container, for example CO₂, N₂O or N₂. Of the gases mentioned, especially CO₂ is preferred in the propellant since it partially dissolves in the prepolymer component and thus enhances the foaming efficiency and, moreover, has good propelling characteristics.

The propellant components account for 5 to 40 wt % of the prepolymer composition. For example, the CO₂ content may amount to approx. 5 wt % based on the entire propellant component. The content of the gases non-condensable under the prevailing pressure conditions should be of such magnitude that the volume relating to the empty space of the pressurized container brings about a pressure of about 8 to 10 bar, max. 12 bar at 50° C., depending on the respective national regulations for pressurized containers (aerosol cans). The empty space of the pressurized container is defined as the space occupied by the non-condensed constituents of the prepolymer composition.

The prepolymer compositions according to the invention may be discharged from customary pressurized cans as one-, 1.5- and two-component systems. In the event of 1.5- and two-component foams the polyol component required for foam hardening is now kept separate from the prepolymer composition in a known manner and is only added immediately before or when the foam is expelled. Methods to this effect have been described frequently elsewhere and are known to those skilled in the art which is also the case for suitable two-component pressurized cans.

Aside from the prepolymer composition the invention also relates to a method for the production of such a prepolymer composition, pressurized cans or cartridges for discharging the prepolymer composition in the form of polyurethane insulating foams as well as the use of the prepolymer composition for the production of polyurethane insulating foams.

The inventive prepolymer compositions are produced in a manner known per se to persons skilled in the art, with the prepolymer being produced both inside and outside the pressurized can. Thus, the required additives as mentioned hereinbefore are added to the prepolymer inside the pressurized can. Following this, the aerosol pressurized can is closed and the propellant injected.

Aside from using pressurized cans also cartridges may be put to use. In that case, the prepolymer components are contained in a cartridge in the absence of a propellant and are discharged from the cartridge by means of a piston.

### EXAMPLES

For the production of the inventive, phase-stable prepolymer compositions polyol blends A with raw MDI at the mixing ratios indicated hereunder are filled into a pressurized can to which the propellant is then added under pressure. All blends resulted in phase-stable products offering good storage capability and foam properties. The polyester polyol was a transesterification product of PET with glycols and soy bean oil.

Polyol component A

| | | | |
|---|---|---|---|
| Polyester polyol | 300 | 270 | 420 |
| Polyester polyol | | 150 | |
| Castor oil | 260 | 260 | |
| Chlorinated paraffin | 420 | 300 | 560 |
| Stabilizer | 10 | 10 | 10 |
| Catalyst | 10 | 10 | 10 |
| Polyol blend | 270 | 270 | 270 |
| Raw MDI | 350 | 345 | 345 |
| Dimethyl ether | 50 | 50 | 55 |
| Propane/butane mixture | 75 | 75 | 84 |

All weighed-in quantities are given in g.

1. Prepolymer composition, in particular for producing polyurethane mounting and insulating foams, said prepolymer composition containing polyurethane prepolymers obtained through the reaction of a first component which contains polyester polyols with at least two hydroxy groups and hydrophobic constituents and a second component containing polyisocyanates having at least two isocyanate groups characterized in that the polyester polyols are at least in part transesterification products of vegetable or animal oils with aromatic di- and/or tricarbonic acids, their esters or anhydrides as well as polyols.

2. Prepolymer composition according to claim 1, characterized in that the content of hydrophobic constituents ranges between 25 and 70 wt % of the first component.

3. Prepolymer composition according to claim 1 or 2, characterized in that at least part of the polyols are glycols.

4. Prepolymer composition according to any one of the claims 1 to 3, characterized in that the polyol at least in part is pentaerythritol.

5. Prepolymer composition according to any one of claims 1 to 4, characterized in that the oil is sunflower oil, corn oil, soy bean oil, castor oil, palm oil, colza oil, groundnut oil, tall oil, fish oil or an animal fat.

6. Prepolymer composition according to any one of claims 1 to 5, characterized in that the content of polyester polyols ranges between 20 and 80 wt % of the first component.

7. Prepolymer composition according to any one of claims 1 to 6, characterized in that the first component contains up to 30 wt % of polyether polyols.

8. Method for the production of a prepolymer composition according to any one of claims 1 to 7, consisting of the following steps:
a) Conversion of polyethylene terephthalate, phthalic acid anhydride or phthalic acid diester with polyols;
b) Conversion of the reaction product obtained through step a) with vegetable oils and/or animal fat;
c) Addition of hydrophobic constituents and, if thought expedient, further additives for the production of a phase-stable first component and
d) Conversion of the first component obtained through step c) with polyisocyanates as second component, said polyisocyanates containing at least two isocyanate groups.

9. Method according to claim 8, characterized in that the content of hydrophobic constituents ranges between 25 and 70 wt % of the first component.

10. Method according to claim 8 or 9, characterized in that glycols are used at least in part as polyols.

11. Method according to any one of the claims 8 to 10, characterized in that pentaerythritol is used at least in part as polyol.

12. Method according to any one of claims 8 to 11, characterized in that as vegetable oil sunflower oil, corn oil, soy bean oil, castor oil, palm oil, colza oil, groundnut oil, tall oil, fish oil or animal fats are used.

13. Method according to any one of claims 8 to 12, characterized in that the content of polyester polyols ranges between 20 and 80 wt % of the first component.

14. Method according to any one of claims 8 to 13, characterized in that the first component contains up to 30 wt % of polyether polyols.

15. Pressurized container or cartridge with a prepolymer composition according to any one of the claims 1 to 7.

16. Pressurized container according to claim 15, characterized in that the pressurized container additionally contains a propellant mixture.

17. Application of the prepolymer composition according to any one of claims 1 to 7 for the production of one-, 1.5- or two-component polyurethane foams.
